(19) United States
(12) Patent Application Publication
(10) Pub. No.: US 2010/0325464 A1
(43) Pub. Date: Dec. 23, 2010

(54) COMPUTER SYSTEM WITH DELAY CIRCUIT

(75) Inventor: KE-YOU HU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/579,244

(22) Filed: Oct. 14, 2009

(30) Foreign Application Priority Data
Jun. 22, 2009 (CN) 200910303495.4

(51) Int. Cl. G06F 1/26

(52) U.S. Cl. 713/330

(57) ABSTRACT

A computer system includes a power supply capable of generating a power good signal, a delay circuit configured to delay the power good signal, a Super I/O chip configured to receive the delayed power good signal; and a front side bus coupled with a terminal voltage signal. A delay time between the delayed power good signal and the terminal voltage signal is not less than a pre-set time limit.

### BACKGROUND

1. Technical Field

The present disclosure relates to a computer system with a delay circuit capable of delaying a power good signal.

2. Description of Related Art

In recent years, a power management technique has been developed known an Advanced Configuration and Power Interface (ACPI). According to the power management technique, power consumption is reduced, and the time for returning from a system state to an operating state is shortened.

The ACPI specification defines system states S0 to S5. The system state S0 is an operating state (e.g., state that system power is turned on, and software is executed). System state S5 is an off state (e.g., state that execution of software ends, and system power is turned off). Each of system states S1 to S4 is a state between the foregoing S0 and S5 (e.g., a so-called sleep state wherein the operating system is shut down while keeping a software execution state).

In system state S4, a non-volatile storage such as hard disk is stored with all of contexts of the system memory, and the power supply to components other than the non-volatile storage is stopped. Power consumption in system state S4 is the minimum (equal to system state S5) of the sleep states. However, state S4 requires the most time to return to state S0 in the sleep states. In other words, system state S4 is the “deepest” of the sleep states.

If a computer system is awakened from the sleep state S4, components on a motherboard of the computer system are powered up. During the power up sequence of the motherboard, there is a plurality of signals (e.g., power good signal, 5V_SYS terminal voltage signal, FSB_VTT signal) in the computer system that should meet a required signal timing sequence. The power good signal is generated from an ATX power supply and sent to a Super I/O chip of the computer system. The FSB_VTT signal is a terminal voltage on a front side bus (FSB). The FSB is the bus that carries data between the CPU and the Northbridge in the computer system. According to the required signal timing sequence, the power good signal fed to the Super I/O chip should rise up later than the FSB_VTT signal with a delay time not less than 99 ms (milliseconds). If the delay time is less than 99 ms, a power up failure will occur, and the computer system cannot return to state S0, the operating state, from the sleep state S4.

### BRIEF DESCRIPTION OF THE DRAWINGS

FIG. 1 a schematic block diagram of a computer system with a delay circuit in accordance with one embodiment;

FIG. 2 illustrates a circuit diagram of the delay circuit in FIG. 1; and

FIG. 3 is a timing diagram of a power good signal and a FSB_VTT signal in the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

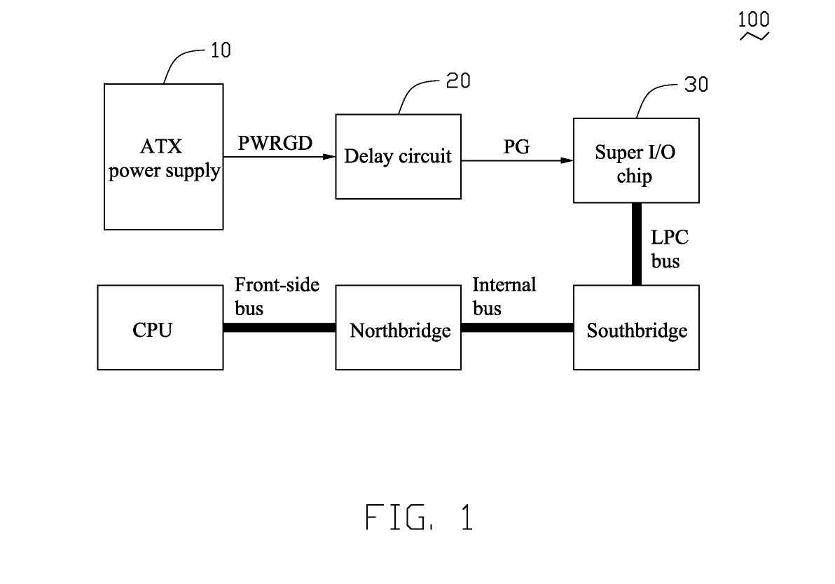

Referring to FIG. 1, an embodiment of a computer system 100 includes an ATX power supply 10, a Super I/O chip 30, and a delay circuit 20 connected between the ATX power supply 10 and the Super I/O chip 30. The ATX power supply 10 is capable of generating and sending a power good (PWRGD) signal to the delay circuit 20. The delay circuit 20 is connected to a power good (PG) pin of the Super I/O chip 30 and sends a delayed power good signal to the Super I/O chip 30. The computer system 100 further includes a central processing unit (CPU), a Northbridge, and a Southbridge (not labeled). The CPU is connected to the Northbridge via a front side bus (FSB). The Northbridge is connected to the Southbridge via an internal bus. The Southbridge is connected to the Super I/O via a low pin count (LPC) bus.

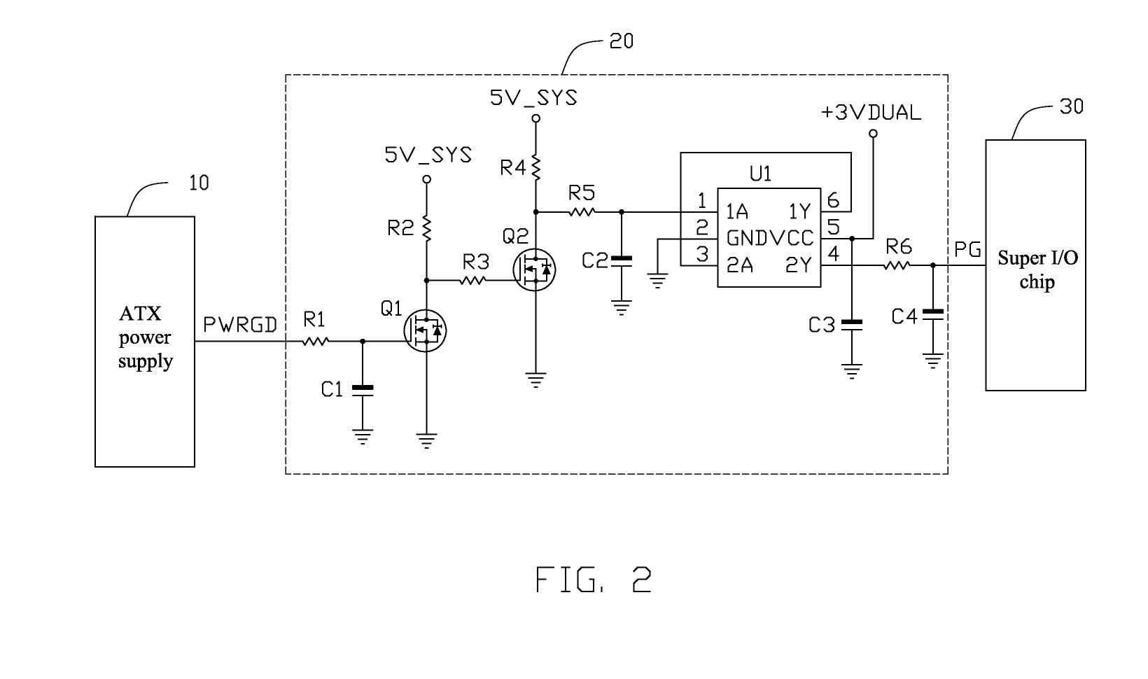

Referring to FIG. 2, the delay circuit 20 includes a first transistor Q1, a second transistor Q2, and a delay chip U1. The first transistor Q1 and the second transistor Q2 are both N-Channel-Enhancement MOSFETS. A gate terminal of the first transistor Q1 is connected to the ATX power supply 10 via a first resistor R1 and further connected to one end of a first filter capacitor C1. Another end of the first filter capacitor C1 is connected to ground. A drain terminal of the first transistor Q1 is fed with a 5V system power 5V_SYS via a second resistor R2 and further connected to a gate terminal of the second transistor Q2 via a third resistor R3. A drain terminal of the second transistor Q2 is fed with the 5V system power 5V_SYS via a fourth resistor R4 and further connected to a first input terminal 1A of the delay chip U1 via a fifth resistor R5. One end of a second filter capacitor C2 is connected to the first input terminal 1A of the delay chip U1, and another end of the second filter capacitor C2 is connected to ground. A source terminal of each of the first transistor Q1 and the second transistor Q2 is connected to ground.

The delay chip U1 includes two integrated inverters, e.g., two NOT gates (not shown). Each of the inverters of the delay chip U1 is capable of inverting a high/low level signal to a low/high level signal and delaying an input signal fed thereto. The following diagram depicts input-output relationships of two input terminals 1A, 2A and two output terminals 1Y, 2Y of the delay chip U1:

Input/Output

| | 1A | 1Y | 2A | 2Y |
|---|---|---|---|---|
| Logic level | Low | High | High | Low |
| | High | Low | Low | High |

The first input terminal 1A is connected to a common node of the fifth resistor R5 and the second filter capacitor C2. The first output terminal 1Y of the delay chip U1 is connected to the second input terminal 2A of the delay chip U1. The second output terminal 2Y of the delay chip U1 is connected to the power good (PG) pin of the Super I/O chip 30 via a sixth resistor R6. A VCC pin of the delay chip U1 is supplied with a +3V power source signal (+3VDUAL), and a GND pin of the delay chip U1 is connected to ground. A third filter capacitor C3 is coupled to the VCC pin of the delay circuit U1, and a fourth filter capacitor C4 is coupled to the power good (PG) pin of the Super I/O chip 30. The first input terminal 1A of the delay chip U1 receives an input signal. The input signal is delayed and inverted one time by one inverter in the delay chip U1 and then sent to the second input terminal 2A of the delay chip U1. Then the input signal is delayed and inverted for another time by another inverter in the delay chip U1 and sent to the Super I/O chip 30 via the second output terminal 2Y of the delay chip U1. The input signal fed to the delay chip U1 is delayed and inverted twice, thereby supplying an output signal which is delayed relative to the input signal, but has a same logic level as the input signal to the Super I/O chip 30.

When the power good (PWRGD) signal from the ATX power supply 10 is at low level; the first transistor Q1 is rendered non-conductive; the second transistor Q2 is turned on and rendered conductive; and a drain-to-source impedance of the second transistor Q2 is very low, thereby connecting the drain terminal of the second transistor Q2 to ground and providing a low level signal to the first input terminal 1A of the delay chip U1. The delay chip U1 delays the low level signal received by the first input terminal 1A and inverts the received signal twice, thereby sending a delayed low level signal (taken as a low level power good signal) to the Super I/O chip 30 via the second output terminal 2Y of the delay chip U1.

When the power good (PWRGD) signal from the ATX power supply 10 is at high level, the first transistor Q1 is rendered conductive and connects the drain terminal of the first transistor Q1 to ground; the second transistor Q2 is turned off and rendered non-conductive, and providing a high level signal to the first input terminal 1A of the delay chip U1. The delay chip U1 delays the high level signal received by the first input terminal 1A and inverts the received signal twice, thereby sending a delayed high level signal (taken as a high level power good signal) to the Super I/O chip 30 via the second output terminal 2Y of the delay chip U1.

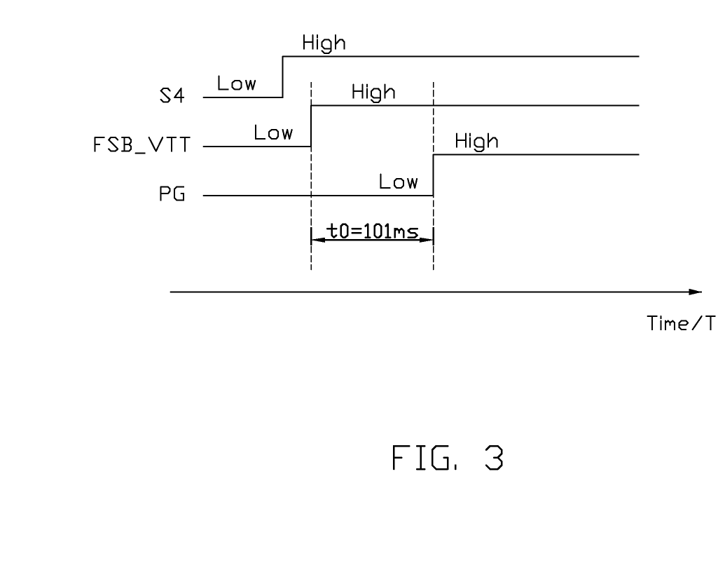

Referring also to FIG. 3, one embodiment, if the computer system 100 is awakened from a sleep state S4, a sleep signal S4 goes to high level. A terminal voltage signal on the front side bus (FSB_VTT) turns from low to high level, and the power good signal (PWRGD) generated by the ATX power supply 10 is turned from low to high level and sent to the Super I/O chip 30 via the delay circuit 20. The power good signal (PWRGD) is delayed by the delay circuit 20, and a signal on the power good (PG) pin of the Super I/O chip 30 is delayed relative to the FSB_VTT signal. A delay time t0 (t0=101 ms) is greater than the specified 99 ms. Thus, the computer system 100 can be normally woken from the sleep state S4 since the required signal timing sequence is satisfied.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A computer system comprising:
a power supply capable of generating a power good signal;
a delay circuit configured to delay the power good signal;
a Super I/O chip configured to receive the delayed power good signal; and
a front side bus coupled with a terminal voltage signal;
wherein the delay circuit is capable of enabling a delay time between the delayed power good signal and the terminal voltage signal not less than a pre-set time limit.

2. The computer system of claim 1, wherein the delay circuit includes a delay chip capable of delaying the power good signal generated by the power supply.

3. The computer system of claim 2, wherein the delay chip comprises two integrated inverters, a first input terminal of the delay chip is configured to receive the power good signal from the power supply, a first output terminal of the delay chip is connected with a second input terminal of the delay chip, and a second output terminal of the delay chip is connected to the Super I/O chip.

4. The computer system of claim 3, wherein the delay circuit further comprises a first transistor and a second transistor connected between the first transistor and the first input terminal of the delay chip.

5. The computer system of claim 4, wherein a gate terminal of the first transistor is connected to the power supply, a drain terminal of the first transistor is coupled with a system power source and further connected to a gate terminal of the second transistor, a drain terminal of the second transistor is coupled with the system power source and further connected to the first input terminal of the delay chip, and a source terminal of each of the first transistor and the second transistor is connected to ground.

6. The computer system of claim 4, wherein the first transistor and the second transistor are both N-Channel-Enhancement MOSFETS.

7. The computer system of claim 1, wherein the predetermined time limit is about 99 milliseconds, and the delay time is about 101 milliseconds.

8. A computer system comprising:
a power supply capable of generating a power good signal;
a delay circuit connected to the power supply for receiving the power good signal, the delay circuit comprising a delay chip capable of inverting and delaying the power good signal; and
a Super I/O chip configured to receive a delayed power good signal from the delay circuit.

9. The computer system of claim 8, further comprising a front side bus coupled with a terminal voltage signal; wherein when the computer system is awaked from a sleep state S4, the terminal voltage signal on the front side bus is capable of turning from low to high level, and the delayed power good signal is capable of turning from low to high level after a time delay since the terminal voltage signal is turned to high level.

10. The computer system of claim 9, wherein the time delay between the terminal voltage signal and the delayed power good signal is not less than 99 milliseconds.

11. The computer system of claim 10, wherein the time delay is about 101 milliseconds.

12. The computer system of claim 8, wherein the delay chip comprises two integrated inverters; a first input terminal of the delay chip is configured to receive the power good signal from the power supply, a first output terminal of the delay chip is connected with a second input terminal of the delay chip, and a second output terminal of the delay chip is connected to the Super I/O chip.

13. The computer system of claim 12, wherein the delay circuit further comprises a first transistor and a second transistor connected between the first transistor and the first input terminal of the delay chip.

14. The computer system of claim 13, wherein a gate terminal of the first transistor is connected to the power supply; a drain terminal of the first transistor is coupled with a system power source and further connected to a gate terminal of the second transistor, a drain terminal of the second transistor is coupled with the system power source and further connected to the first input terminal of the delay chip, and a source terminal of each of the first transistor and the second transistor is connected to ground.

15. The computer system of claim 14, wherein the first transistor and the second transistor are both N-Channel-Enhancement MOSFETS.
